(19) United States
(12) Patent Application Publication
(10) Pub. No.: US 2011/0150434 A1
(43) Pub. Date: Jun. 23, 2011

(54) A Pan camera controlling method

(75) Inventors: Kosuke TAKANO, Kanagawa (JP); Naofumi YOSHIDA, Kanagawa (JP); Shuichi KURABAYASHI, Kanagawa (JP)

(73) Assignee: EMPIRE TECHNOLOGY DEVELOPMENT LLC, Wilmington, DE (US)

(21) Appl. No.: 12/645,837

(22) Filed: Dec. 23, 2009

(51) Int. Cl. H04N 5/00; H04N 5/228; H04N 5/917; H04N 5/783

(52) U.S. Cl. 386/328; 348/222.1; 348/E05.031; 386/E05.003; 386/355; 386/349

(57) ABSTRACT

In accordance with embodiments of the present disclosure, a process for controlling a pan camera is presented. The process may be implemented to record, by the pan camera, a first set of video clips corresponding to a plurality of scene areas, wherein each of the first set of video clips is generated by recording one of the plurality of scene areas according to a video capturing scheme. The process may, in response to a data request for a first video clip of a scene area selected from the plurality of scene areas, retrieve the first video clip from the previously recorded first set of video clips. The process may also adjust the video capturing scheme for a subsequent video recording.

### BACKGROUND

Unless otherwise indicated herein, the approaches described in this section are not prior art to the claims in this application and are not admitted to be prior art by inclusion in this section.

A device equipped with a video camera may be configured to capture video data associated with the subjects presented in front of the camera lens. The captured video data may then be saved to data storage. The stored video data can be retrieved from the data storage and played back as a series of video images showing the subjects. The video camera may support image enhancement functions such as zooming. For a public video camera that is constantly recording its surrounding environment, even with the image enhancement functions, the video camera may be restricted to capture video data from one specific angle of view at a time. Thus, for areas that are not covered within the angles of views supported by the video camera, no video data may be available.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 illustrates an example of extended video coverage provided by using multiple pan cameras;

FIG. 2 illustrates an exemplary system that may be configured to distribute video data captured by a sharable pan camera to a client device;

FIG. 3A illustrates the mechanism of a video capturing scheme;

FIG. 3B illustrates scenarios of adjusting a video capturing scheme;

FIG. 4 is a flow diagram illustrating a process for adjusting video capturing scheme based on a data request;

FIG. 5 is a flow diagram illustrating a process for configuring and adjusting video capturing scheme based on a data request;

FIG. 6 illustrates an example computer program product; and

FIG. 7 is a block diagram illustrating an example computing device, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, computer programs, and systems related to a data processing server capable of controlling pan cameras and distributing video data captured by the pan cameras. Throughout the disclosure, the term “pan camera” may broadly refer to a fixed or mobile video camera having panning functionalities. Panning may refer to the rotating of a camera's lens in various dimensions during video recording. For example, similar to shaking a person's head from left-to-right, the pan camera may rotate, or pan, its lens in a horizontal dimension to scan a vast area, which cannot be covered by a single viewing angle of the camera lens. The pan camera may also pan vertically, like moving a person's head up-and-down, to cover a long alley or a tall building. The horizontal and vertical panning may be performed simultaneously. Thus, the panning of a video camera not only may provide extended video coverage of a subject under recording, but also may be used to record moving subjects. The term “scene area” may broadly refer to an area of interest of which the pan camera may capture video images. For example, a scene area may be a street, a public square, or a particular room. Further, once a pan camera uses its panning or zooming functions to capture a set of video images for a specific scene area, the set of video images may be stored as a “video clip.” Therefore, each video clip may be associated with a specific scene area. By replaying the video clip, video images previously recorded from the scene area can be viewed again.

Throughout the disclosure, the term “video capturing scheme” may broadly refer to a set of operational configurations and instructions to control the video capturing operations of one or more pan cameras. For example, a video capturing scheme may configure the amount of video capturing time for a pan camera to cover a particular subject or scene area. The video capturing scheme may also contain operational parameters that may be used to control the physical operation of one or more pan cameras. Thus, based on a particular video capturing scheme, a data processing server may control multiple pan cameras to record video clips for different scene areas. In addition, the video capturing scheme may allow the pan camera to be systematically controlled, without human interaction, during its video capturing operation. Furthermore, the video capturing scheme may be adjustable for a subsequent video recording.

In accordance with at least some embodiments of the present disclosure, a process for controlling a pan camera is presented. The process may be implemented to record, by the pan camera, a first set of video clips corresponding to a plurality of scene areas, wherein each of the first set of video clips is generated by recording its corresponding scene area according to a video capturing scheme. The process may, in response to a data request for a video clip of a scene area selected from the plurality of scene areas, retrieve the requested video clip from the previously recorded first set of video clips. The process may also adjust the video capturing scheme for a subsequent video recording.

In accordance with at least some embodiments of the present disclosure, a data processing server is connected with a pan camera. The data processing server may have a pan camera control unit configured to control the pan camera to capture a set of video clips corresponding to a plurality of scene areas. The data processing server may further contain a video retrieval unit coupled with the pan camera control unit to retrieve a video clip from the set of video clips, in response to receiving a data request for the video clip.

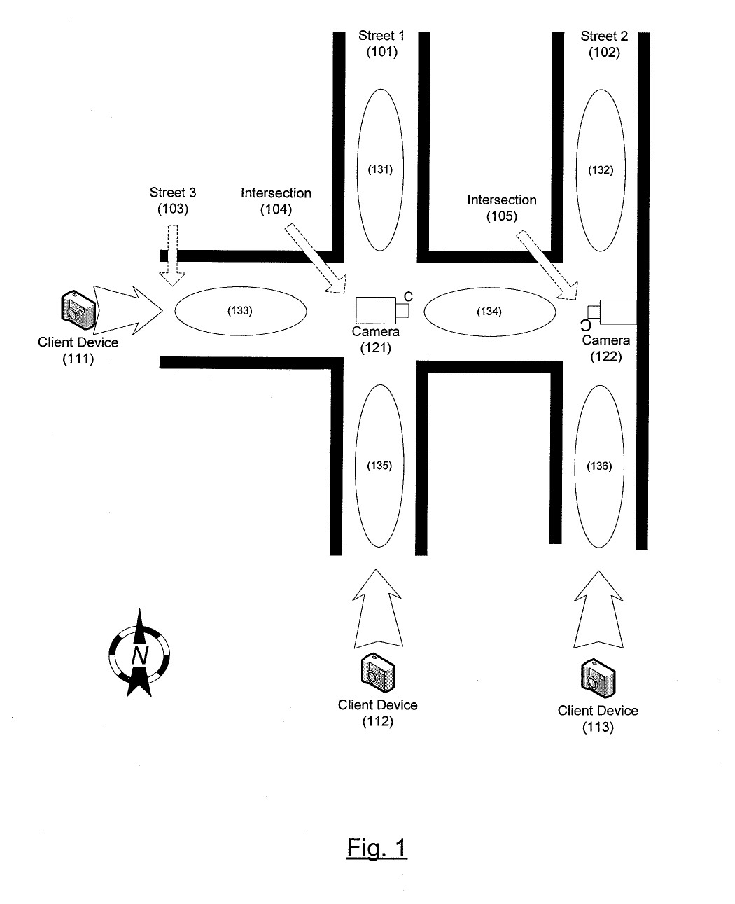

FIG. 1 illustrates an example of extended video coverage provided by using multiple pan cameras, in accordance with at least some embodiments of the present disclosure. FIG. 1 may show three public streets 101, 102 and 103. Street 101 and street 102 may run from north to south direction and may be parallel to each other. Street 103 may run from east to west direction, and may intersect with street 101 and street 102 at intersections 104 and 105, respectively. In other words, street 101 and street 103 form a cross intersection 104. And street 102 and street 103 form a T-intersection 105. Two pan cameras 121 and 122 may be installed at the two intersections 104 and 105 to monitor the traffic conditions on the streets and intersections. The pan camera 121 may be configured to pan in a 360-degree rotation to capture video images of the street 101 and 103, as well as the intersections 104 and 105. The pan camera 122 may be configured to pan in a 180-degree rotation to capture video images of the street 102 and 103, and the intersections 104 and 105.

In one implementation, four scene areas 131, 133, 134 and 135 may be defined as the places that require the pan camera 121 to provide video images. Similarly, three scene areas 132, 134 and 136 may be defined as the points-of-interest the pan camera 122 may be responsible for. Thus, in order to capture video data for the scene areas 131, 133, 134 and 135, the pan camera 121 may need to know the location of these scene areas, and need to pan horizontally and/or vertically during recording. Likewise, the pan camera 122 may require detail information about the scene areas 132, 134 and 136 for its recording operations. In this case, a video capturing scheme may provide such information to the pan cameras 121 and 122, allowing the pan cameras to capture video images that may satisfy data requests. The details about the video capturing scheme are further described below.

In one implementation, the client devices 111, 112, 113 may be computing devices that can display video images. For example, the client devices 111, 112 and 113 may be car video systems capable of showing the front-view or rear-view images of the street conditions. In one implementation, the client devices 111, 112 and 113 may be equipped with video cameras to capture video images when the vehicle is traveling on the streets. In FIG. 1's example, the client device 111 may be positioned in the street 103 with its lens pointing toward the east direction (right). The client devices 112 and 113 may be placed in the streets 101 and 102 respectively, with their lenses pointing toward the north direction (up). Thus, the client device 111 may be configured to capture video and/or still images of scene areas 133 and 134. However, if the client device 111 lacks a wide-angle lens, or when some of the scene areas are blocked by street corners or buildings, then the client device 111 may not be able to directly obtain video images of scene areas 131, 132, 135, and/or 136. Likewise, the client device 112 may be able to directly view scene areas 131 and 135, but not be able to obtain video images of the scene areas 132, 133, 134, and/or 136. And the client device 113 may see the scene areas 132 and 136 directly, but not the scene areas 131, 133, 134, and/or 135.

In one implementation, the client devices 111, 112, and 113 may be configured to show, in a picture-in-picture format or otherwise, an augmented reality (AR) environment. The augmented reality may create a mixed reality by merging real-life elements and virtual-reality elements into a single graphical view. In other words, in the augmented reality environment, the physical real-world graphic elements and the virtual, artificial graphic elements may be rendered and displayed together, forming a single image. In one implementation, an augmented reality environment may be generated by combining video images directly obtained by a client device (e.g., client device 111) with video images the client device unable to obtain directly. For example, the video images of the scene areas 133 and/or 134, which may be directly obtained by the client device 111, may be merged with video clips that contain the scene areas 131 and 135, in order to show a complete 360-degree AR view of the cross-intersection 104. Also, video clips from the scene areas 132 and 136, which may be directly obtainable by the client device 113, may be combined with video clips from the scene area 134, to form a 180-degree AR view of the T-intersection 105.

In one implementation, a client device may request for video clips of the scene areas it cannot directly view from a data processing server. In this case, the client device 113 may request for video clips for the scene area 134, which may be captured either by the pan camera 121 or pan camera 122, for generating an AR environment for the intersection 105. Alternatively, based on a client device's current physical location, the data processing server may automatically determine these scene areas that the client device may not have direct access to, and provide the video clips of these scene areas to the client device.

For example, upon a determination that the client device 112 may be on a vehicle driving north on the street 101 and is approaching the intersection 104, the data processing server may be able to determine that the client device 112 may have a directly view of the scene areas 131 and 135, but not the scene areas 133 and 134. The data processing server may further decide that the client device 112 may be interested in the scene areas 133 and 134, which are not directly viewable from the perspective of the client device 112 either. Thus, by providing the video clips of the scene areas 133 and 134 previously recorded by the pan camera 121 to the client device 112, the client device 112 may be able to display an AR environment that may show the traffic condition at the intersection 104. Likewise, the video clips of the scene areas 132 and 136, which may be obtained by the pan camera 122, may be transferred to the client device 112 for creating an AR environment for the intersection 105. Therefore, by obtaining video clips for the blocked scene areas from the data processing server, the AR environment may nevertheless provide an expanded view of the real-time or near real-time traffic condition at these blocked scene areas, allowing a driver to pick an ideal driving route and to minimize the impact of the traffic congestions.

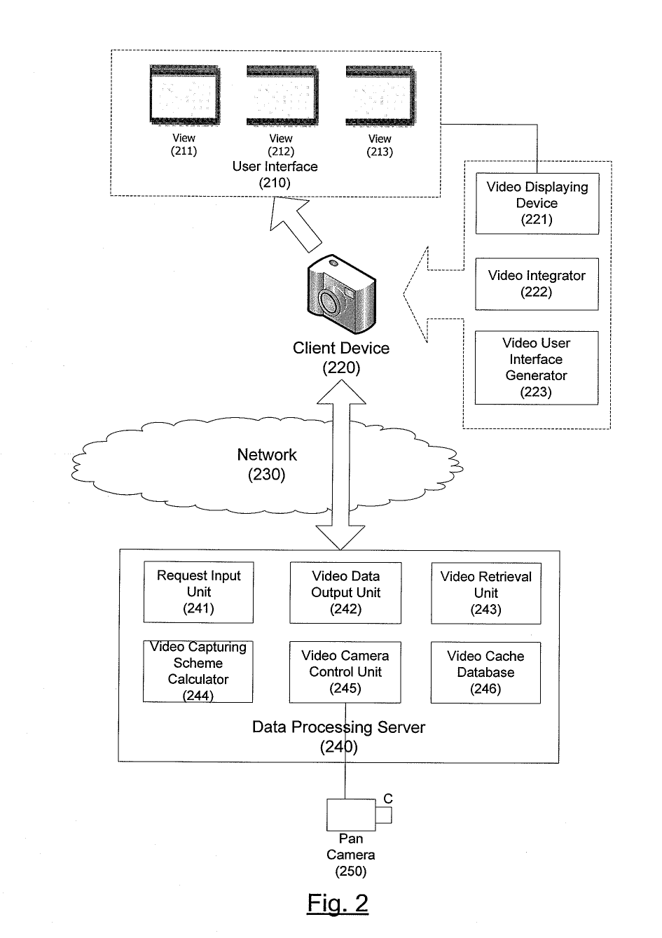

FIG. 2 illustrates an exemplary system that may be configured to distribute video data captured by a sharable pan camera to a client device, in accordance with at least some embodiments of the present disclosure. The system in FIG. 2 may be configured to include a client device 220, a data processing server 240 and a pan camera 250. The client device 220, which may be one of the client devices 111, 112, and 113 of FIG. 1, may be configured to have a user interface 210 to display multiple image views 211, 212 and 213. The client device 220 may further contain, without limitation, a video displaying device 221, a video integrator 222, and a video user interface generator 223. The data processing server 240 may contain, without limitation, a request input unit 241, a video data output unit 242, a video retrieval unit 243, a video capturing scheme calculator 244, a video camera control unit 245, and/or a video cache database 246. Further, the data processing server 240 may be connected with one or more pan cameras 250.

In one implementation, the client device 220 may be configured as a device that can play back video images on a user interface 210 contained therein. The client device 220 may further be a computing device that is capable of communicating with other applications and/or devices in a network environment. The client device 220 may be a mobile, handheld, and/or portable device, such as, without limitation, a Personal Digital Assistant (PDA), cell phone, smart-phone, GPS, video recorder, or MP3/MP4 player. The client device 220 may also be a tablet computer, a laptop computer, a netbook, and/or a specifically designed computing device. For example, the client device 220 may be a compact computer integrated into a vehicle's road condition monitoring system.

In one implementation, during operation, the client device 220 may communicate with a data processing server 240 via a network 230. The network 230 may be a wired network, such as, without limitation, local area network (LAN), wide area network (WAN), metropolitan area network (MAN), global area network such as the Internet, a Fibre Channel fabric, or any combination of such interconnects. The network 120 may also be a wireless network, such as, without limitation, mobile device network (GSM, CDMA, TDMA, and others), wireless local area network (WLAN), and wireless Metropolitan area network (WMAN).

In one implementation, the data processing server 240 may receive data requests from one or more client devices 220, and respond to the client devices 220 with the requested video clips. The data processing server 240 may also control one or more pan cameras 250 for the obtaining of video clips from multiple scene areas. The data processing server 240 may include a request input unit 241, which is configured to receive a data request from one or more client devices 220 via the network 230. The data request may contain one or more identifications of the scene areas the client device is interested in, and/or identification of one of the pan cameras controlled by the data processing server 240. The data request may also contain a time range specifying interests in video clips recorded within this time range. Upon receiving the data request, the data processing server 240 may instruct a video retrieval unit 243 to retrieve the requested video clips from a video cache database 246, and send the retrieved video clips to the client device 220 through a video data output unit 242, via the network 230. Before sending the video clips back, the video data output unit 242 may attach additional information, such as timestamp for the data request, video clip identification, pan camera identification, etc., with the video clips.

In one implementation, the data processing server 240 may also contain a video camera control unit 245 to control one or more pan cameras 250 that may be installed in public streets or public areas. The pan camera 250 may be a video capturing device that has the capabilities of, without limitation, panning, zooming, and auto-focusing. The captured video data may be transmitted to the data processing server 240 in a digitized format, allowing quick storage and fast retrieval. Further, the captured video data may be stored as one or more video clips. Since the data processing server 240 defines the boundaries of the scene areas and controls the operations of the pan cameras 250, it may be aware of that a particular pan camera 250 is panning from one scene area to another, based on the pan camera's operational parameters, and automatically process the video data received from the pan camera into multiple video clips, each of which is associated with one scene area. After processing, each video clip may have an identification of the corresponding scene area, and may have a timestamp storing the exact time the video clip is captured. The timestamp may also be used for data management in the video cache database 246.

In one implementation, the processed video clips may be stored in the video cache database 246. Video clips stored in the video cache database 246 may be organized based on the scene areas, timestamps, the pan camera's identity, and other attributes. The video cache database 246 may be configured to store the latest video data for each scene area. In another embodiment, the video cache database 246 may be configured to retain the past video clips of the same scene area. Based on their timestamps, the video retrieval unit 243 may be able to differentiate these video clips of the same scene area, and may retrieve the video clips by the scene area identification (e.g., scene area 131 or scene area 132, etc) and/or by a time range (e.g., start-time to end-time).

In one implementation, the data processing server 240 may contain a video capturing scheme calculator 244. The video capturing scheme calculator 244 may be configured to store, calculate and determine a video capturing scheme for capturing video clips for all the scene areas and by all the pan cameras 250 under its management. Based on the video capturing scheme, the video camera control unit 245 may be able to control each of the pan cameras 250 in panning and capturing of the video clips for the different scene areas. Details of the video capturing scheme are further described below.

In one embodiment, upon receiving a data request from a client device 220, the data processing server 240 may retrieve one or more video clips, which may be inaccessible by the client device 220, from the video cache database, and transmit the video clips back to the client device 220. The client device 220 may integrate, by the video integrator 222, the received video clips with any real-time video images directly captured by the client device 220 to generate an AR environment. Further, the video user interface generator 223 of the client device 220 may be configured to generate and manage a user interface 210. The generated user interface 210 may then be displayed on a video displaying device 221 of the client device 220.

In one implementation, the user interface 210 displayed on the video displaying device 221 may show multiple views 211, 212 and 213. Each of the views 211, 212 and 213 may either play a video clip retrieved from the data processing server 240, or play a video clip directly recorded by the client device 220. For example, the view 212 may display a video captured by the client device 220 (e.g., client device 112 of FIG. 1), showing the street view of the scene area 135 in FIG. 1. The view 211 may play a video clip of the scene area 133 retrieved from the data processing server 240. And the view 213 may show a video clip of the scene area 134, which is also retrieved from the data processing server 240. By displaying the three views side-by-side, the user interface 210 may present a convenient AR overview of the road condition at the intersection 104 from the perspective of the client device 220. Alternatively, the views 211, 212 and 213 may display video clips of the scene areas 132, 134 and 136, all of which are retrieved from the data processing server 240. In this case, the traffic situation at the intersection 105 may be displayed in an AR environment, even for a client device (e.g., client device 112 of FIG. 1) that cannot have direct access to these scene areas.

In one implementation, the user interface 210 may display the views 211, 212 and 213 in a picture-in-picture AR arrangement. Further, the user interface 210 may include functions allowing a user to specify which pan camera and/or scene area the user is interested in. The user interface 210 may also show a list of available pan cameras and scene areas to prompt user selection. The client device 220 may send the user's selections as a part of a data request to the data processing server. In one embodiment, the client device 220 may automatically select one or more pan cameras and scene areas nearby, or on a route to a destination, so that the client device 220 may automatically obtain video clips without having to wait for user inputs.

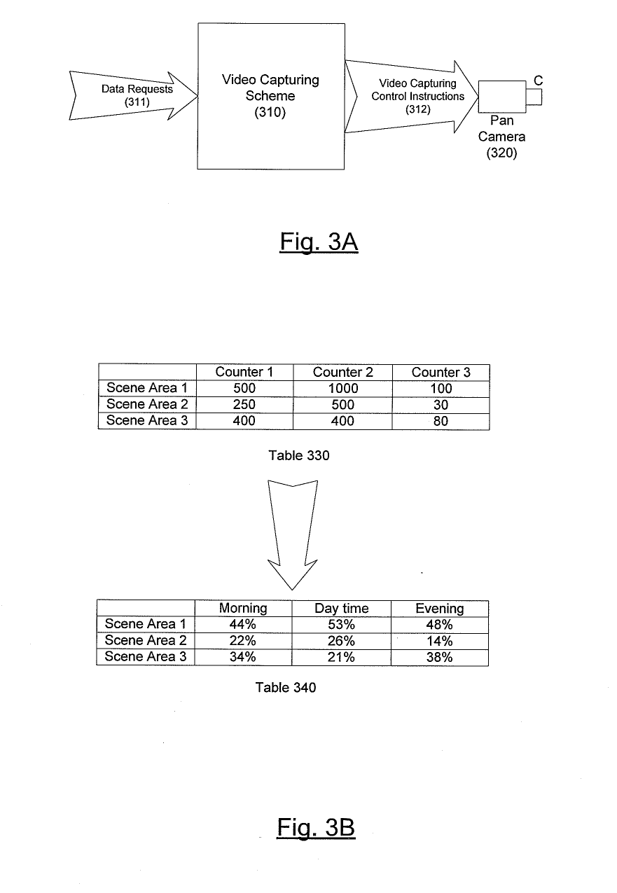

FIG. 3A illustrates the mechanism of a video capturing scheme, in accordance with at least some embodiments of the present disclosure. In FIG. 3A, a video capturing scheme 310 may be a set of operational configurations and instructions to control one or more pan cameras' video capturing operations. In one implementation, the operational configurations may contain video capturing parameters such as, without limitation, horizontal and vertical panning orientations, panning angles, starting panning positions, ending panning positions, panning speed, zooming setup, and zooming speed. The operational instructions may include commands to control a pan camera, such as, without limitation, starting and stopping recording, and adjusting the camera according to the operational configurations. Based on the video capturing scheme, a video camera control unit may generate and transmit a set of video capturing control instructions 312 to a pan camera 320 to remote control the camera.

In one implementation, one or more data requests 311 received by a data processing server may be utilized to adjust the operational configurations and instructions of the video capturing scheme 310. The data requests 311 may be received by the request input unit 241 of FIG. 2, and transmitted to the video capturing scheme calculator 244 to adjust the video capturing scheme 310 managed therein. Further, subsequent data requests 311 may be continuously forwarded to the video capturing scheme calculator 244 for further adjusting of the video capturing scheme 310, allowing the pan cameras 320 to capture video clips that truly serve the needs of the client devices.

In one implementation, demands of video clips for different scene areas may change depending on various factors. For example, a single scene area may have different traffic conditions during the morning rush hour comparing to the evening rush hour. When a specific scene area receives more data requests than the other scene areas, the users who are interested in the scene area may want to see more details (quality and quality) in the video clips taken from the specific scene area. Thus, when serving data requests with video clips that have previously been recorded, the video capturing scheme calculator may further utilize the data requests to adjust subsequent video capturing operations, thereby allowing the quality and the quality of the video clips to serve the actual needs of the client devices.

FIG. 3B illustrates scenarios of adjusting a video capturing scheme, in accordance with at least some embodiments of the present disclosure. In FIG. 3B, table 330 and table 340 are internal data structures of a video capturing scheme, and may be associated with a specific pan camera. Thus, each pan camera controlled by the video capturing scheme may have corresponding tables 330 and 340. In FIG. 3B's example, table 330 may be used to analyze time-based data requests for a specific pan camera. In table 330, three scene areas (e.g., scene area 1, scene area 2, and scene area 3) may be defined for the specific pan camera. For each scene area, three counters may be configured to store the number of data requests received during different periods of time. For example, counter 1 may be used for storing data requests received during morning time (e.g., 5 AM-9 AM). Counter 2 may be configured for storing data requests received during the daytime (e.g., 9 AM-6 PM). And counter 3 may be configured for saving data requests received throughout the night (e.g., 6 PM-5 AM). By evaluating table 330, a video capturing scheme calculator may have an accurate overview of the demands for the scene areas associated with a specific pan camera.

In one implementation, all the fields in table 330 may start with some pre-defined initial values. The table 330 in FIG. 3 may be the result of collecting the data requests after a 24-hour period. For scene area 1, there have been 500 data requests received during morning time; 1000 data requests received during the daytime; and 100 data requests received during evening time, respectively. Tale 330 further shows that during the morning day, 500 data requests were received for scene area 1; 250 data requests were received for scene area 2; and 400 data requests were received for scene area 3. Based on the information in the table 330, a second table 340 may be generated by the video capturing scheme calculator to determine how to allocate the pan camera's resources to cover these three scene areas. In table 340, a request ratio, which is a percentage number, may be calculated for each time period with respect to the three scene areas. For example, during the morning time period, 44% of the client devices may be requesting for video clips for scene area 1, 22% for scene area 2, and 34% for scene area 3. Thus, by calculating the ratios of data requests for each time period among the different scene areas, the data processing server may be able to adjust the pan camera according to the time of the day.

In one implementation, when controlling the specific pan camera, the data processing server may allocate the pan camera's processing time and resources based on each scene area's request ratio. In FIG. 3B's example, 44% of the pan camera resources may be allocated to cover scene area 1, 22% of the resources to cover scene area 2, and the rest of the resources to cover scene area 3. During the morning time period, the resources of pan camera may be allocated or distributed among the scene areas based on the ratios calculated in table 340. Thus, the pan camera may be instructed to spend more capturing time on the scene area 1 by panning in slower motion or having more zooming or panning operations, in order to ensure that 44% of the time and resources are spent on scene area 1. When the pan camera is rotated toward scene area 2, the data processing server may operate the pan camera in a faster pace, with fewer zooming operations, and utilizing about 22% of the time and resources. Thus, a video clip for the scene area 1 may contain twice as much information as a video clip for scene area 2, even though both video clips where generated during a same period of time.

In one embodiment, the video capturing scheme may be adjusted based at least in part on a rate of change in the previously recorded video clips. For example, when the video capturing scheme calculator determines that there is no change between multiple video clips captured from a single scene area, the video capturing scheme calculator may lower the priority of capturing additional video data for this scene area, thereby allowing the pan camera to bypass the recording for this particular scene area and spend more time and resources on the other scene areas. In this case, the video capturing scheme calculator may set the scene area's corresponding counter in the table 330 to a lower number, or to zero, which in term would reduce or eliminate the spending of the pan camera's time and resources on the scene area.

In one implementation, the rate of change may be determined based at least in part on inter-frame dissimilarity among the video clips for the same scene area. The inter-frame dissimilarity of the video clips may be determined by conducting a comparison of the color component, contour features, and the like. If the differences in color component or contour feature of the video clips are below a minimum threshold, then the video capturing scheme calculator may determine that the video clips have a rate of change that may be ignorable, and instruct the pan camera to skip further video capturing for the scene area. Further, the rate of change may be periodically monitored or re-examined for every predetermined period of time. Thus, once an above-the-threshold rate of change has been detected, the video capturing scheme calculator may increase the corresponding counter in table 330, so that newer video clips may be subsequently captured for the specific scene area.

In one implementation, the data processing server may further adjust the video capturing scheme to fine-tune the operation of the pan camera. For example, when a particular scene area has not been videotaped by the pan camera for a predetermined amount of time (e.g., 10 minutes), the video capturing scheme calculator may increase the scene area's corresponding counter with some value, so that the request ratio for the particular scene area may be increased, which in turn would trigger the pan camera to spend more time and resources to capturing the particular scene area.

In one embodiment, the video capturing scheme may be determined based at least in part on the combination of the number of data requests and the rate of change in video clips for each of the scene areas. Further, various other types of configurations may be utilized to prioritize the pan camera's operational tasks. By constantly updating and adjusting the video capturing scheme based on data requests, the data processing server may provide an optimal approach in serving video clips for different scene areas.

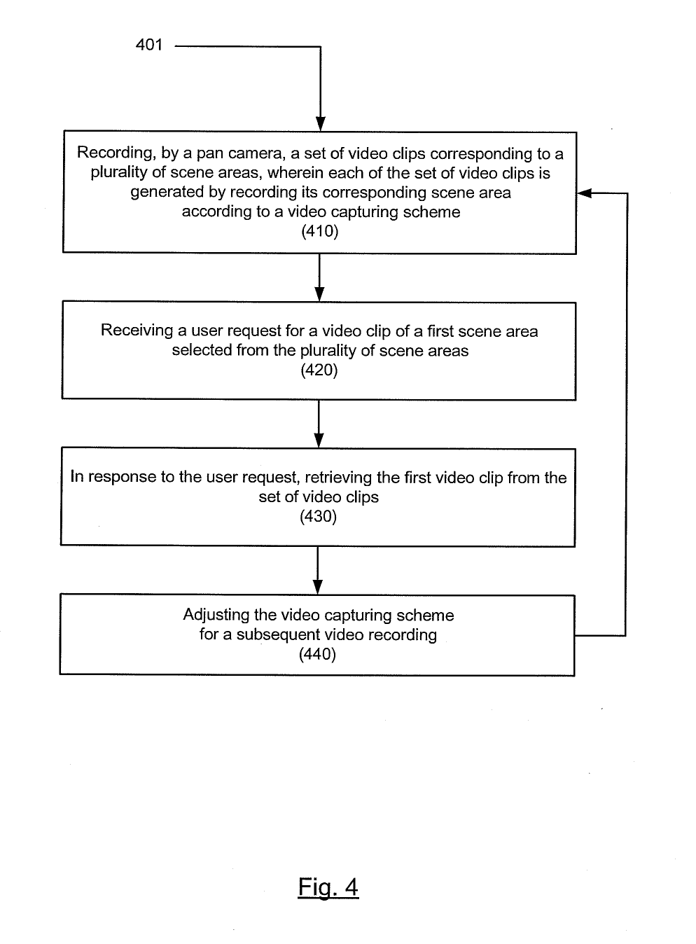

FIG. 4 illustrates a flow diagram of an example process 401 for adjusting video capturing scheme based on a data request, in accordance with at least some embodiments of the present disclosure. The process 401 set forth various functional blocks or actions that may be described as processing steps, functional operations, events, and/or acts, etc., which may be performed by hardware, software, and/or firmware. Those skilled in the art in light of the present disclosure will recognize that numerous alternatives to the functional blocks shown in FIG. 4 may be practiced in various implementations. In one embodiment, machine-executable instructions for the process 401 may be stored in memory, executed by a processor, and/or implemented in a data processing server of FIG. 2.

Process 401 may begin at block 410, “recording, by a pan camera, a set of video clips corresponding to a plurality of scene areas, wherein each of the set of video clips is generated by recording one of the plurality of scene areas according to a video capturing scheme.” Block 410 may be followed by block 420, “receiving a data request for a first video clip of a first scene area selected from the plurality of scene areas.” Block 420 may be followed by block 430, “in response to the data request, retrieving the first video clip from the set of video clips.” Block 430 may be followed by block 440, “adjusting the video capturing scheme for a subsequent video recording.” Block 440 may be following by block 410, and the process 401 may be repeated. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

At block 410, a data processing server may instruct a pan camera to record a set of video clips for a plurality of scene areas. The data processing server and its various components may utilize a video capturing scheme to control the pan camera's operations and to allocate the pan camera's resources among the plurality of scene areas.

At block 420, the data processing server may receive a data request transmitted from a client device. The data request may identify a specific scene area, which is one of the plurality of scene areas under the surveillance of the pan camera, and request for a first video clip of the scene area. The data request may further contain a time range, seeking a specific video clip that has previously been recorded within such a time range. In one implementation, at block 430, based on the scene area identification in the data request, the data processing server may retrieve the requested first video clip from the set of video clips recorded at block 410. Alternatively, the data processing server may retrieve a previously stored video clip from a video cache database, based on the time range received at block 420.

At block 440, the data processing server may adjust the video capturing scheme for a subsequent video recording. In one implementation, the video capturing scheme is adjusted based on the data request. For example, the data processing server may increment a specific counter associated with the scene area based on the time of the day the data request is processed. Thus, a “morning time” counter may be incremented when a data request is received during morning time. Afterward, the counter may be used to adjust the video capturing scheme, and the adjusted video capturing scheme may be used to control the pan camera for a subsequent video recording. In one implementation, the video capturing scheme may be adjusted based on a rate of change in video data previously recorded the scene area. Thus, for a scene area with little activity, the video capturing scheme may be adjusted accordingly, and less pan camera resources may be allocated to cover such a scene area. In one implementation, the process 401 may proceed to block 410 from block 440 to repeat the above operations.

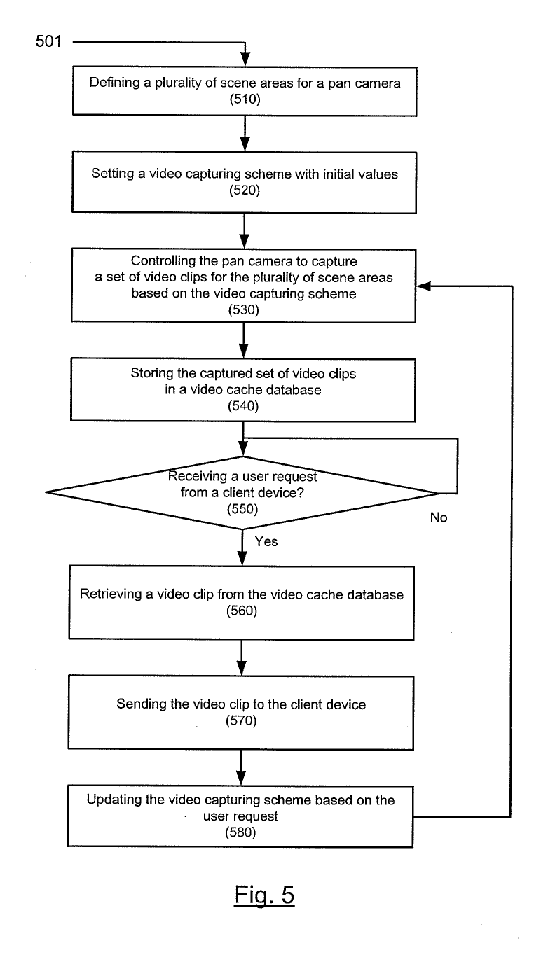

FIG. 5 illustrates a flow diagram of an example process 501 for configuring and adjusting video capturing scheme based on a data request, in accordance with at least some embodiments of the present disclosure. The process 501 set forth various functional blocks or actions that may be described as processing steps, functional operations, events, and/or acts, etc., which may be performed by hardware, software, and/or firmware. Those skilled in the art in light of the present disclosure will recognize that numerous alternatives to the functional blocks shown in FIG. 5 may be practiced in various implementations. In one embodiment, machine-executable instructions for the process 501 may be stored in memory, executed by a processor, and/or implemented in a data processing server of FIG. 2.

Process 501 may begin at block 510, “defining a plurality of scene areas for a pan camera.” Block 510 may be followed by block 520, “setting a video capturing scheme with initial values.” Block 520 may be followed by block 530, “controlling the pan camera to capture a set of video clips for the plurality of scene areas based on the video capturing scheme.” Block 530 may be followed by block 540, “storing the captured set of video clips in a video cache database.” At block 550, a determination of whether a data request is received from a client device is made. Block 550 may be following by block 560, “retrieving a video clip from the video cache database,” when the determination at block 550 returns “Yes.” Alternative, the process 501 may stay at block 550 waiting for further data requests. Block 560 may be followed by block 570, “sending the video clip to the client device.” Block 570 may be followed by block 580, “updating the video capturing scheme based on the data request.” The process 401 may be repeated starting at block 530. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

At block 510, a data processing server may define a plurality of scene areas for a pan camera. The scene areas may be defined from the perspective of the pan camera. For example, if the pan camera is placed at a cross-intersection, then at least four scene areas may be defined to cover the four directions from the intersection. The scene area definitions may be panning angle parameters that can be transmitted to the pan camera. For example, if the pan camera may be capable of panning in a 360-degree horizontal dimension, then the data processing server may define a particular scene area utilizing a start-panning-angle value and an end-panning-angle value, both values being in a 360-degree measurement range. Thus, when the lens of the pan camera is rotated into these two angle values, the video images recorded by the pan camera may be deemed for that particular scene area. Alternatively, additional camera operational parameters may be used for defining the scene areas.

At block 520, a video capturing scheme may be utilized by the data processing server in controlling of the pan camera. The data processing server may set the various configurations and parameter values with initial values, either manually or automatically. For example, the counters for various scene areas may be initialized with the same values. At block 530, the data processing server may control, based on the video capturing scheme, the pan camera to capture a set of video clips for the plurality of scene areas. Each video clip in the set of video clips may be corresponding to one of the plurality of scene areas. At block 540, the captured set of video clips may be stored in a video cache database for subsequent retrieval. The video cache database may be controlled and managed by the data processing server.

In one implementation, at block 550, a determination may be made to evaluate whether a data request from a client device is received by the data processing server. If no data request is received, process 501 may await at block 550 for further data requests. If a data request is received, process 501 proceeds to block 560. The data request may seek a video clip associated with a scene area. At block 560, the data processing server may retrieve the requested video clip from the video cache database. At block 570, in response to the data request received at block 550, the data processing server may send the video clip retrieved at block 560 to the client device. At block 580, the data request may further be utilized to update the video capturing scheme, as described above. The video capturing scheme may then be used to control the pan camera for a subsequent recording of the plurality of scene areas when the process 501 proceeds from block 580 to block 530.

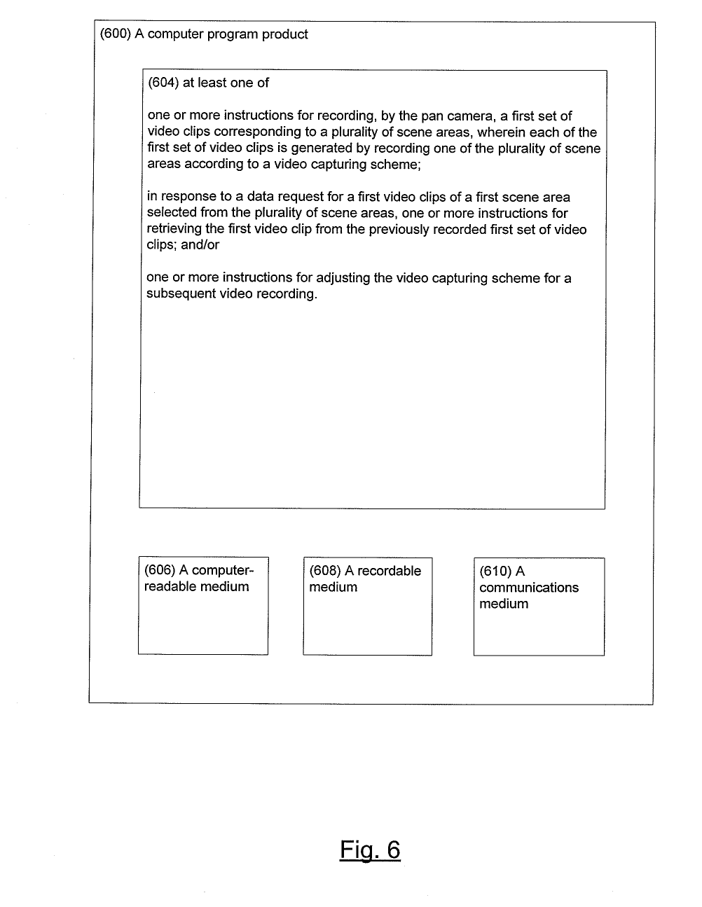

FIG. 6 illustrates an example computer program product 600 that is arranged in accordance with the present disclosure. Program product 600 may include one or more machine-readable instructions 604, which, if executed by one or more processors, may operatively enable a computing device to provide the functionality described above. Thus, for example, referring to the system of FIG. 2, the data processing server may undertake one or more of the operations shown in at least FIG. 4 or FIG. 5 in response to instructions 604.

In some implementations, the program product 600 may encompass a computer-readable medium 606, such as, but not limited to, a hard disk drive, a Compact Disc (CD), a Digital Versatile Disk (DVD), a digital tape, memory, etc. In some implementations, signal bearing medium 602 may encompass a recordable medium 608, such as, but not limited to, memory, read/write (R/W) CDs, R/W DVDs, etc. In some implementations, the program product 600 may encompass a communications medium 610, such as, but not limited to, a digital and/or an analog communication medium (e.g., a fiber optic cable, a wired communications link, a wireless communication link, etc.).

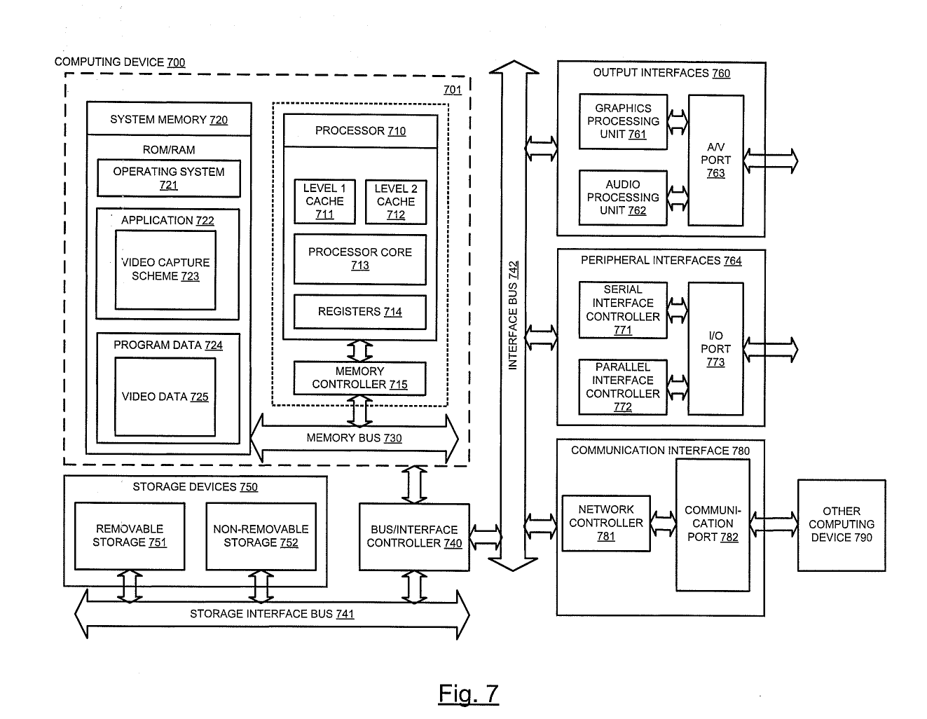

FIG. 7 is a block diagram illustrating an example computing device 700 that is arranged in accordance with the present disclosure. In one example configuration 701, computing device 700 may include one or more processors 710 and system memory 720. A memory bus 730 can be used for communicating between the processor 710 and the system memory 720.

Depending on the desired configuration, processor 710 may be of any type including but not limited to a microprocessor (μP), a microcontroller (μC), a digital signal processor (DSP), or any combination thereof. Processor 710 can include one or more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the processor 710, or in some implementations the memory controller 715 can be an internal part of the processor 710.

Depending on the desired configuration, the system memory 720 may be of any type including but not limited to volatile memory (such as RAM), non-volatile memory (such as ROM, flash memory, etc.) or any combination thereof. System memory 720 may include an operating system 721, one or more applications 722, and program data 724. Application 722 may include a video capturing scheme 723 in a data processing server 240 (FIG. 2) that is arranged to perform the functions and/or operations as described herein including at least the functional blocks and/or operations described with respect to process 400 of FIG. 4 and process 500 of FIG. 5. Program Data 724 may include video data 725 for use in video data cache algorithm 723. In some example embodiments, application 722 may be arranged to operate with program data 724 on an operating system 721 such that implementations of mobile sampling may be provided as described herein. This described basic configuration is illustrated in FIG. 7 by those components within dashed line 701.

Computing device 700 may have additional features or functionality, and additional interfaces to facilitate communications between the basic configuration 701 and any required devices and interfaces. For example, a bus/interface controller 740 may be used to facilitate communications between the basic configuration 701 and one or more data storage devices 750 via a storage interface bus 741. The data storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 720, removable storage 751 and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of device 700.

Computing device 700 may also include an interface bus 742 for facilitating communication from various interface devices (e.g., output interfaces, peripheral interfaces, and communication interfaces) to the basic configuration 701 via the bus/interface controller 740. Example output interfaces 760 may include a graphics processing unit 761 and an audio processing unit 762, which may be configured to communicate to various external devices such as a display or speakers via one or more A/V ports 763. Example peripheral interfaces 760 may include a serial interface controller 771 or a parallel interface controller 772, which may be configured to communicate with external devices such as input devices (e.g., keyboard, mouse, pen, voice input device, touch input device, etc.) or other peripheral devices (e.g., printer, scanner, etc.) via one or more I/O ports 773. An example communication interface 780 includes a network controller 781, which may be arranged to facilitate communications with one or more other computing devices 790 over a network communication via one or more communication ports 782. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 700 may also be implemented as a personal computer including both laptop computer and non-laptop computer configurations. In addition, computing device 700 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or a firmware configuration; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), ARM Processors, CPUs or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of the skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, Flash Memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

We claim:

1. A data processing server connected with a pan camera, comprising:
a pan camera control unit configured to control the pan camera to capture a set of video clips corresponding to a plurality of scene areas, wherein each of the set of video clips is generated by recording one of the plurality of scene areas according to an adjustable video capturing scheme; and
a video retrieval unit coupled with the pan camera control unit to retrieve a first video clip from the set of video clips, in response to receiving a data request for the first video clip.

2. The data processing server as recited in claim 1, further comprising:
a video capturing scheme calculator coupled with the video retrieval unit and the pan camera control unit, wherein the video capturing scheme calculator is configured to adjust the video capturing scheme based on the data request.

3. The data processing server as recited in claim 2, wherein the video capturing scheme calculator is configured to allocate resources of the pan camera based on a number of data requests for video data associated with each of the plurality of scene areas.

4. The data processing server as recited in claim 2, wherein the video capturing scheme calculator is configured to adjust allocating of the resources of the pan camera based on a rate of change in video data previously recorded for the plurality of scene areas.

5. The data processing server as recited in claim 1, further comprising:
a video data output unit coupled with the video retrieval unit, wherein the video data output unit is configured to send the first video clip to a sender of the data request.

6. The data processing server as recited in claim 5, further comprising:
a client device coupled with the video data output unit, wherein the client device is the sender of the request, and the client device is configured to playback the first video clip in an augmented-reality user interface.

7. The data processing server as recited in claim 5, wherein the client device is configured to lack a direct access to a scene area corresponding to the first video clip for video recording.

8. A method for controlling a pan camera, comprising:
recording, by the pan camera, a first set of video clips corresponding to a plurality of scene areas, wherein each of the first set of video clips is generated by recording one of the plurality of scene areas according to a video capturing scheme;
in response to a data request for a first video clip of a first scene area selected from the plurality of scene areas, retrieving the first video clip from the previously recorded first set of video clips; and
adjusting the video capturing scheme for a subsequent video recording.

9. The method as recited in claim 8, further comprising:
recording a second set of video clips corresponding to the plurality of scene areas, wherein each of the second set of video clips is generated by recording one of the plurality of scene areas according to the adjusted video capturing scheme.

10. The method as recited in claim 9, wherein the video capturing scheme enables allocating of a corresponding portion of resources for the pan camera to support each of the plurality of scene areas.

11. The method as recited in claim 8, wherein the video capturing scheme enables controlling of the pan camera to pan one of the plurality of scene areas for a specific amount of time.

12. The method as recited in claim 8, wherein the video capturing scheme enables controlling of the pan camera to bypass recording for one of the plurality of scene areas, which is associated with a rate of change in previously recorded video data that is below a predetermined threshold.

13. The method as recited in claim 8, wherein the rate of change is determined by comparing inter-frame dissimilarity in the previously recorded video data.

14. The method as recited in claim 8, wherein the first video clip corresponds to the latest recorded video clip.

15. The method as recited in claim 8, wherein the first video clip is recorded within a time range provided by the data request.

16. The method as recited in claim 8, wherein the method is embodied in a machine-readable medium as a set of instructions which, when executed by a computing processor, cause the computing processor to perform the method.

17. A method for controlling a pan camera, comprising:
recording, by the pan camera, a set of video clips for a plurality of scene areas based on a video capturing scheme;
storing the set of video clips associated with to the plurality of scene areas;
receiving, from a client device, a data request for a video clip of a scene area selected from the plurality of scene areas;
retrieving the requested video clip from the first set of video clips based on the requested scene area; and
updating, based on the data request, the video capturing scheme for a subsequent video recording.

18. The method as recited in claim 17, further comprising:
defining the plurality of scene areas for the pan camera; and
setting the video capturing scheme with initial values.

19. The method as recited in claim 17, wherein the recording of the set of video clips further comprising:
controlling the pan camera based on configurations defined in the video capturing scheme.

20. The method as recited in claim 17, wherein the updating of the video capturing scheme further comprising:
calculating a request ratio for each of the plurality of scene areas based on previous data requests.
